(19) United States
(12) Patent Application Publication
(10) Pub. No.: US 2008/0006302 A1
(43) Pub. Date: Jan. 10, 2008

(54) SUBSTRATE TREATMENT METHOD AND SUBSTRATE TREATMENT APPARATUS

(76) Inventors: Hiroyuki Araki, Kyoto (JP); Masahiro Miyagi, Kyoto (JP); Masanobu Sato, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/773,629

(22) Filed: Jul. 5, 2007

(30) Foreign Application Priority Data
Jul. 6, 2006 (JP) 2006-186758

(51) Int. Cl. B08B 3/00

(52) U.S. Cl. 134/26; 134/94.1

(57) ABSTRACT

The substrate treatment method includes a deionized water supply step of supplying deionized water on a surface of a substrate; a resistivity reducing gas supply step of supplying a resistivity reducing gas so as to change ambient air to which the deionized water in contact with the surface of the substrate is exposed, into an ambient of the resistivity reducing gas capable of reducing the resistivity of deionized water; and a deionized water removal step of removing the deionized water from the surface of the substrate after the resistivity reducing gas supply step.

### BACKGROUND OF THE INVENTION

1. Field of the Invention

The present invention relates to a substrate treatment method including a step of supplying deionized water on a substrate, and to a substrate treatment apparatus suitable for conducting the substrate treatment method. Examples of the substrate to be treated includes semiconductor wafers, substrates for liquid crystal display panels, substrates for plasma display devices, substrates for FED (Field Emission Display), substrates for optical disks, substrates for magnetic disks, substrates for magneto-optical disks, and substrates for photo-masks.

2. Description of Related Art

Production processes for semiconductor devices or liquid crystal display panels employ a substrate treatment apparatus for processing a semiconductor substrate or a glass substrate with a treatment liquid (a chemical or a rinse liquid) For example, the substrate treatment apparatus of a single substrate processing type comprises a spin chuck which holds a substrate to rotate, a chemical nozzle which supplies a chemical to the substrate held by the spin chuck, and a deionized water nozzle which supplies deionized water to the substrate held by the spin chuck. A chemical step is performed that supplies a chemical from the chemical nozzle onto a surface of the substrate while the substrate is rotated by the spin chuck. Subsequently, a rinsing step is performed that supplies deionized water on the substrate from the deionized water nozzle to replace the chemical present on the substrate with deionized water. Thereafter, a drying step is further performed that rotates the spin chuck at a high rotation speed in order to spin off the deionized water on the substrate by a centrifugal force. The substrate rotation speed in the chemical step and the rinsing step is generally from several tens to several hundreds of rpm (revolution/min), and the supply flow rates of the chemical and the deionized water are, for example, several liters/min.

When the substrate has an insulating layer formed on a surface thereof, or the substrate itself is of an insulator such as a glass substrate, the substrate surface thereof is an insulator surface. Therefore, in the rinsing step, deionized water moves on the insulator surface at a high speed. Thus, static electricity is produced by triboelectric charge and stripping charge, resulting in a charged substrate. If the static electricity accumulated on the charged substrate causes electric discharge, the insulating layer on the substrate surface may be broken down, or a pattern defect may occur, which in turn damages devices fabricated on the substrate. Thus, the static electricity accumulated on a substrate can seriously affect the quality of the substrate.

Then, as disclosed in Japanese Unexamined Patent Publication No. 2003-68692 and US Patent Application Publication No. 2005/0133066 A1, there has been proposed that a rinsing step is performed using a CO₂-dissolved water obtained by dissolving carbon dioxide in deionized water. The CO₂-dissolved water has small resistivity as compared with deionized water, so that static electricity produced by triboelectric charge or stripping charge can be dissipated from a substrate to a spin chuck or the like. This can complete the substrate treatment with almost no charge on the substrate.

For example, as described in US Patent Application Publication No. 2005/0133066 A1, the CO₂-dissolved water is prepared by dissolving high-pressure carbon dioxide in deionized water through a gas dissolving membrane, such as hollow fiber type separation membrane in the middle of piping, or by bubbling carbon dioxide in deionized water. However, since carbon dioxide has metal and other contaminants incorporated therein as impurities, these impurities can be incorporated into deionized water at the same time when carbon dioxide is dissolved into deionized water. Therefore, there arises a problem in that when the CO₂-dissolved water is supplied onto a substrate surface, such impurities are inevitably supplied thereonto, resulting in poor cleanliness of the substrate as compared with the case of rinsing the substrate with deionized water.

Another problem is that when a metal film, such as a copper film, is exposed on the substrate surface, the metal film is subject to corrosion by the CO₂-dissolved water.

### SUMMARY OF THE INVENTION

It is an object of the present invention to provide a substrate treatment method and a substrate treatment apparatus that can suppress or prevent charging on a substrate while suppressing a problem of substrate contamination caused by impurities in resistivity reducing gas, or metal film corrosion on a substrate.

The substrate treatment method of the present invention includes a deionized water supply step of supplying deionized water on a surface of a substrate; a resistivity reducing gas supply step of supplying a resistivity reducing gas so as to change ambient air to which the deionized water in contact with the surface of the substrate is exposed, into an ambient of the resistivity reducing gas capable of reducing the resistivity of deionized water; and a deionized water removal step of removing the deionized water from the surface of the substrate after the resistivity reducing gas supply step.

According to the present invention, when the ambient air to which the deionized water in contact with the surface of the substrate is exposed, is changed into the ambient of the resistivity reducing gas, the resistivity reducing gas is dissolved into the deionized water, and thus the resistivity of the deionized water becomes low. Therefore, even if the substrate is charged by triboelectric charge and/or stripping charge resulting from supplying of deionized water onto the surface thereof, static electricity accumulated on the substrate is removed through the deionized water having reduced resistivity (deionized water having a resistivity reducing gas dissolved therein). This allows put the substrate in a state where static electricity is hardly accumulated thereon after the deionized water is removed from the substrate surface.

On the other hand, in the above-mentioned conventional technique of supplying onto a substrate the CO₂-dissolved water prepared by dissolving carbon dioxide in deionized water in the middle of piping, all the impurities in the carbon dioxide are supplied onto a substrate. In contrast, according to the present invention, ambient air to which the deionized water in contact with a surface of the substrate is exposed, is turned into an ambient of resistivity reducing gas, so that even if some impurities are contained in the resistivity reducing gas, the probability that such impurities are dissolved into deionized water becomes low. That is, not all the impurities in the resistivity reducing gas are dissolved into the deionized water on the substrate. This allows suppression of contamination by the impurities in the resistivity reducing gas.

Further, in the conventional technique of performing the rinsing step using the CO₂-dissolved water, the CO₂-dissolved water is in contact with the substrate for a long time, so that the copper film or other metal film is disadvantageously subject to corrosion as described above. In contrast, the present invention is adapted to reduce the resistivity of deionized water by dissolving a resistivity reducing gas present in ambient air into the deionized water, so that the time for which the deionized water having the resistivity reducing gas dissolved therein is in contact with the substrate can be shortened. Therefore, even if the deionized water having dissolved resistivity reducing gas is corrosive to a metal film on a substrate, the corrosion to the metal film can be minimized.

A substrate to be treated may have, for example, an insulator at least on a surface thereof. Such a substrate may be, for example, a semiconductor substrate having an insulator film, such as an oxide film, formed on a surface thereof, or may be of an insulator itself, such as a glass substrate. When the present invention is applied to the treatment of a substrate, the process can be completed with the substrate in good antistatic state while both contamination of the substrate surface and corrosion of the metal film are prevented.

Gases capable of reducing the resistivity of deionized water include rare gases, such as xenon (Xe), krypton (Kr), or argon (Ar), and methane gas, as well as carbon dioxide. Any of these gases can reduce the resistivity of deionized water by supplying the gas into ambient air to which deionized water is exposed, thereby dissolving the gas into deionized water.

The deionized water supply step, the resistivity reducing gas supply step, and the deionized water removal step are preferably performed in a treatment chamber (in a single treatment chamber). In this case, the resistivity reducing gas supply step preferably includes a step of supplying a resistivity reducing gas in the treatment chamber. In this way, after or during the deionized water supply step, a gas capable of reducing the resistivity of deionized water is supplied into the treatment chamber, so that the gas can be dissolved into the deionized water which is in contact with the substrate surface. Therefore, charges on the substrate can be removed through the deionized water having the resistivity reducing gas dissolved therein, without requiring a complicated structure such that carbon dioxide is dissolved into deionized water in the middle of piping.

The resistivity reducing gas supply step preferably includes a step of supplying a resistivity reducing gas toward the surface of the substrate. This allows reduction of consumption of the resistivity reducing gas. At the same time, the resistivity reducing gas can securely be supplied to the deionized water which is in contact with the surface of the substrate. In addition, since the usage of the resistivity reducing gas can be reduced, the contamination of the substrate by the impurities therein can further be suppressed.

The resistivity reducing gas supply step and the deionized water removal step may be performed simultaneously. By supplying (e.g., spraying) the resistivity reducing gas to the surface of the substrate, it is possible to dissolve the resistivity reducing gas into the deionized water on the substrate, and, at the same time, to remove the deionized water therefrom. This can further shorten the time for which the deionized water having dissolved resistivity reducing gas is in contact with the substrate. Further, since the resistivity reducing gas supply step and the deionized water removal step can be performed simultaneously, the total substrate treatment time can be shortened.

The deionized water supply step preferably includes a deionized water puddle step of puddling deionized water on a surface of a substrate generally horizontally held by a substrate holding mechanism. In this case, ambient air to which the puddled deionized water is exposed is an ambient of resistivity reducing gas. Only a small amount of deionized water (e.g., about 100 ml of deionized water on a 300 mm-diameter circular substrate) is in contact with the surface of the substrate, so that when a small amount of resistivity reducing gas is supplied to ambient air in the vicinity of the substrate surface, the resistivity of the deionized water puddled on the substrate can be reduced sufficiently (to allow removal of charges from the substrate). This reduces the amount of the resistivity reducing gas used. Accordingly, mixing of the impurities contained in the resistivity reducing gas into the deionized water can further be prevented, whereby contamination of the substrate can be suppressed or prevented even more effectively.

The deionized water removal step preferably includes a substrate inclining step of inclining a substrate having a horizontal posture, thereby flowing down the deionized water on the substrate. According to this process, a substrate is inclined with respect to a horizontal plane, whereby the deionized water on the substrate is flown down, which in turn can remove the deionized water out of the substrate. Therefore, scattering of the deionized water to the environment can be reduced, as compared with the case where the deionized water is removed by a substrate rotation step of rotating the substrate at a high speed to spin off the deionized water.

Since the resistivity reducing gas is dissolved in the deionized water on the substrate to be removed in the deionized water removal step, even if the deionized water removal step is performed by the substrate rotation step of rotating the substrate to remove the deionized water on the substrate by a centrifugal force, the substrate rotation step may not generate undesirable charges on the substrate. Therefore, as long as the scattering of deionized water to the environment is not disadvantageous, the substrate rotation step may be applicable to the deionized water removal step.

Preferably, the process further includes a grounding step of grounding the deionized water on the substrate through a conductive member. According to this process, the deionized water on the substrate is grounded through a conductive member, thereby ensuring removal of the static electricity accumulated on the substrate.

The substrate treatment apparatus of the present invention includes a treatment chamber, a substrate holding mechanism which holds a substrate in the treatment chamber, a deionized water supply unit which supplies deionized water to the substrate held by the substrate holding mechanism, a resistivity reducing gas supply unit, having a gas outlet port in the treatment chamber, which discharges a resistivity reducing gas from the gas outlet port in order to turn ambient air on a surface of the substrate held by the substrate holding mechanism into an ambient of the resistivity reducing gas capable of reducing the resistivity of deionized water, and a deionized water removal unit which removes deionized water from the surface of the substrate held by the substrate holding mechanism.

With this arrangement, the resistivity reducing gas from the resistivity reducing gas supply unit can be dissolved into the deionized water supplied to the substrate held by the substrate holding mechanism in the treatment chamber. Thus, even if the substrate is charged with static electricity, the static electricity can be dissipated through the deionized water having the resistivity reducing gas dissolved therein.

Different from the conventional techniques of dissolving carbon dioxide within piping, or bubbling carbon dioxide in deionized water, the arrangement of the present invention is adapted to supply a resistivity reducing gas to the deionized water in a relatively large space in the treatment chamber while the deionized water is in contact with the substrate. Therefore, the probability that impurities in the resistivity reducing gas adhere to the substrate surface can be lowered. It is also possible to shorten the time for which the deionized water having the resistivity reducing gas dissolved therein is in contact with the substrate, so that even if a metal film is formed on the substrate surface, the corrosion thereof can be minimized.

The resistivity reducing gas supply unit may produce an ambient of resistivity reducing gas in the treatment chamber. The resistivity reducing gas supply unit may also supply a small amount of resistivity reducing gas to a space in the vicinity of the surface of the substrate.

The resistivity reducing gas supply unit may include a gas nozzle unit which removes deionized water on the substrate by blowing the resistivity reducing gas toward the surface of the substrate. In this case, the resistivity reducing gas supply unit can also serve as the deionized water removal unit. The gas nozzle unit may be, for example, a gas knife mechanism which scans the substrate surface while blowing off a gas to a linear region (straight, curved, bent, etc.) of the substrate surface.

The deionized water removal unit may include a substrate inclining mechanism which inclines the substrate to flow down deionized water from the surface of the substrate, or a substrate rotation mechanism which rotates a substrate at a high speed by a centrifugal force to spin off the deionized water on the substrate.

These and other features, objects, advantages and effects of the present invention will be more fully apparent from the following detailed description set forth below when taken in conjunction with the accompanying drawings.

### BRIEF DESCRIPTION OF THE DRAWINGS

FIG. 1 is a schematic diagram for explaining the arrangement of a substrate treatment apparatus according to a first embodiment of the present invention;

FIG. 2 is a schematic diagram illustrating an example of a substrate treatment flow in sequence of steps according to the first embodiment;

FIG. 3 is a flowchart for explaining the operation of a substrate treatment apparatus corresponding to the treatment flow of FIG. 2;

FIG. 4 is a schematic sectional view for explaining the arrangement of a substrate treatment apparatus according to a second embodiment of the present invention;

FIG. 5 is a schematic plan view of the apparatus of FIG. 4;

FIG. 6 is a block diagram illustrating the arrangement related to a control of the apparatus of FIG. 4.

FIG. 7 is a schematic diagram illustrating an example of a substrate treatment flow in sequence of steps according to the second embodiment;

FIG. 8 is a flowchart for explaining the operation of a substrate treatment apparatus corresponding to the treatment flow of FIG. 7; and

FIG. 9 is a schematic view for explaining the arrangement of a substrate treatment apparatus according to a third embodiment of the present invention.

### DETAILED DESCRIPTION OF PREFERRED EMBODIMENTS

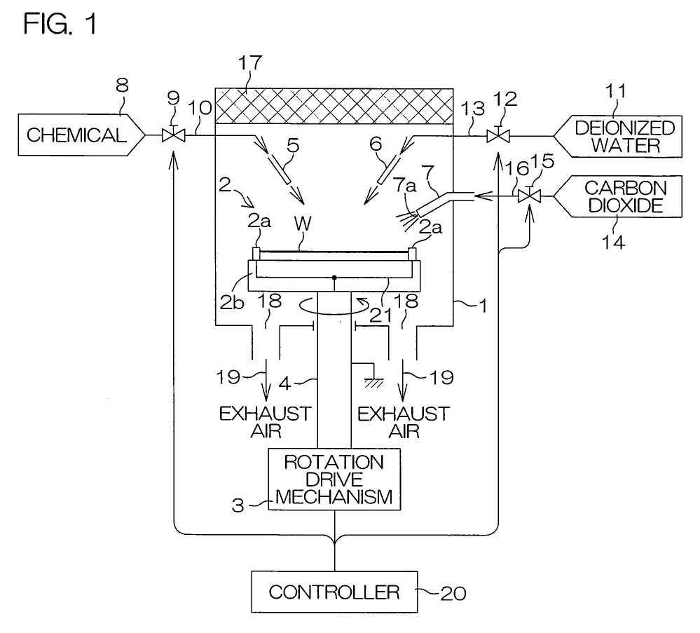

FIG. 1 is a schematic diagram for explaining the arrangement of a substrate treatment apparatus according to a first embodiment of the present invention. The substrate treatment apparatus is installed for use in a clean room, and is a type of single substrate processing to carry a substrate W in a treatment chamber 1 one-by-one to perform a treatment. The substrate W is, for example, generally round. An example of the round substrate is a semiconductor wafer (e.g., having an insulating layer, such as an oxide film and a nitride film, formed on a surface thereof). A glass substrate for producing liquid crystal panels for liquid crystal projectors is also an example of the round substrate.

A spin chuck 2 is arranged as a substrate holding mechanism in the treatment chamber 1. The spin chuck 2 can hold a substrate W generally horizontally to be rotated about a vertical axis, and has a plurality of holding pins 2a which clamp an outer peripheral surface of the substrate W, and a disc-shaped spin base 2b having these holding pins 2a installed upright on a peripheral portion of its upper surface. A torque is applied to the spin base 2b through a rotation shaft 4 from a rotation drive mechanism 3 (deionized water removal unit) as a substrate rotation mechanism arranged outside the treatment chamber 1. This allows the spin chuck 2 to rotate the substrate W about a vertical axis while holding the substrate W.

The holding pins 2a are made of a conductive material (e.g., conductive PEEK (polyether ether ketone resin)). These holding pins 2a are electrically connected to the rotation shaft 4 through an electric discharge path 21 formed in the spin base 2b. The rotation shaft 4 is made of metal, and grounded outside the treatment chamber 1.

Further, a chemical nozzle 5 and a deionized water nozzle 6 (deionized water supply unit) which supply a chemical and deionized water, respectively, to the substrate W held by the spin chuck 2 are provided in the treatment chamber 1. Further, carbon dioxide can be supplied as a resistivity reducing gas through a gas nozzle 7 (resistivity reducing gas supply unit) into the treatment chamber 1.

The gas nozzle 7 has an outlet port 7a (gas outlet port) in the treatment chamber 1, and the outlet port 7a is oriented toward the upper surface of the substrate W held by the spin chuck 2. Thus, carbon dioxide can be efficiently supplied near the upper surface of the substrate W, and the supply of a small amount of carbon dioxide can turn the ambient air near the upper surface of the substrate W into an ambient of carbon dioxide having a high concentration.

A chemical from a chemical supply source 8 is supplied to the chemical nozzle 5 through a chemical supply pipe 10. A chemical valve 9 is provided in the chemical supply pipe 10. On the other hand, deionized water from a deionized water supply source 11 is supplied to the deionized water nozzle 6 through a deionized water supply pipe 13. A deionized water valve 12 is provided in the deionized water supply pipe 13. Carbon dioxide from a carbon dioxide supply source 14 is supplied to the gas nozzle 7 from a carbon dioxide supply pipe 16. A carbon dioxide valve 15 is provided in the carbon dioxide supply pipe 16.

A filter unit 17 for further cleaning clean air in a clean room to incorporate the clean air thus cleaned into the environment of the substrate W is arranged in the upper portion of the treatment chamber 1. On the other hand, an exhaust port 18 is formed in the lower portion of the treatment chamber 1. The exhaust port 18 is connected, through an exhaust pipe 19, to an exhaust utility in the plant where the substrate treatment apparatus is installed. Thus, a downward air flow is formed in the treatment chamber 1.

A controller 20 including a microcomputer controls operation of the rotation drive mechanism 3, and opening and closing of the chemical valve 9, the deionized water valve 12, and the carbon dioxide valve 15.

According to the arrangement as described above, a chemical and deionized water can be supplied from the chemical nozzle 5 and the deionized water nozzle 6, respectively, with respect to the substrate W held by the spin chuck 2. Further, supplying of carbon dioxide into the treatment chamber 1 from the gas nozzle 7 makes it possible to turn ambient air around the substrate W into an ambient of carbon dioxide.

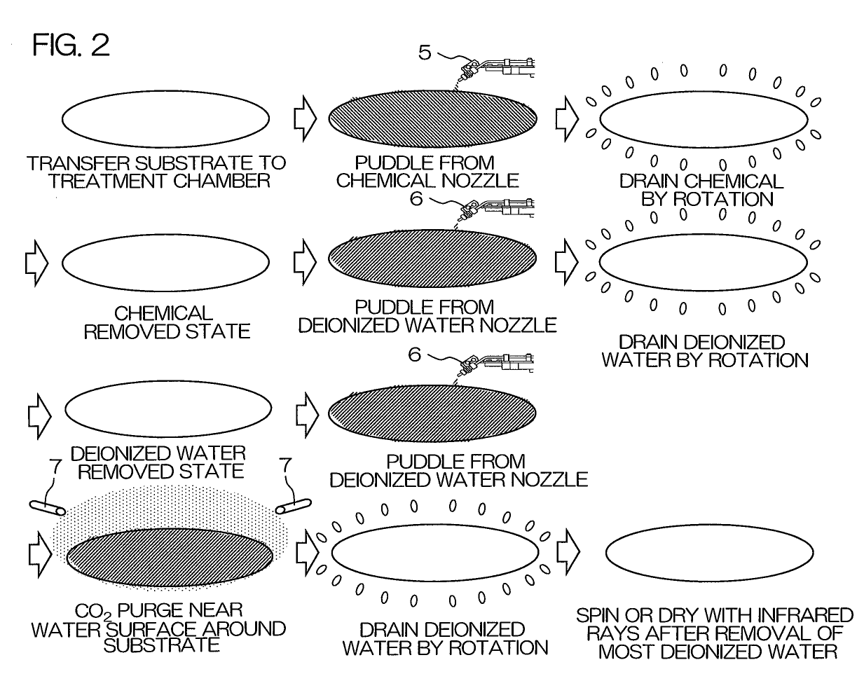

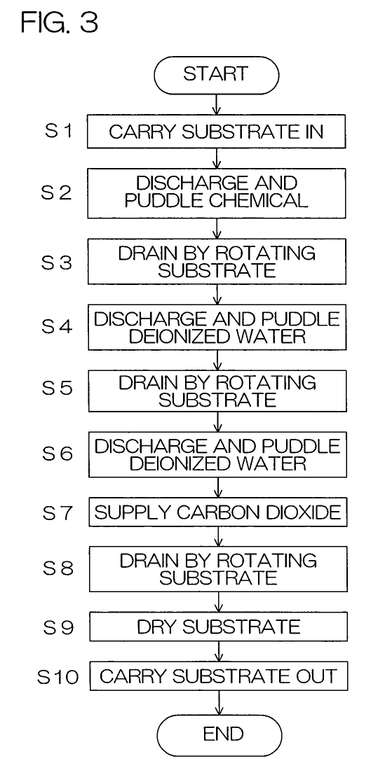

FIG. 2 is a schematic diagram illustrating an example of a treatment flow of a substrate W in sequence of steps, and FIG. 3 is a flowchart for explaining the operation of an substrate treatment apparatus corresponding to the treatment flow.

An unprocessed substrate W is carried in the treatment chamber 1 by a substrate transfer robot, which is not shown, and is transferred to the spin chuck 2 (Step S1). Thus, the substrate W is horizontally held by the spin chuck 2.

From such state, the controller 20 opens the chemical valve 9. The chemical from the chemical supply source 8 is thus sent to the chemical nozzle 5 through the chemical supply pipe 10, and then, the chemical is discharged from the chemical nozzle 5 toward the upper surface of the substrate W. At this time, the controller 20 maintains the rotation drive mechanism 3 in a stop state, so that the spin chuck 2 is put in a rotation stop state, thereby maintaining the substrate Win a stationary state. In this way, the chemical is discharged onto the stationary substrate W, whereby the chemical is puddled on the substrate W to form a liquid film of the chemical on the upper surface of the substrate W (Step S2). The chemical from the chemical nozzle 5 may be discharged over a period of time in which a chemical liquid film can cover the entire upper surface of the substrate W, and after the lapse of the time, the controller 20 closes the chemical valve 9 to stop the supply of the chemical. However, in order to reliably maintain the state in which the entire upper surface of the substrate W is covered with the chemical, the chemical supply from the chemical nozzle 5 (preferably supply at a smaller flow rate than the initial supply flow for liquid film formation) may be continued. In this way, the chemical liquid film thus formed on the upper surface of the substrate W is maintained over a predetermined time. In the meantime, the action of the chemical which forms the liquid film progresses the treatment of the upper surface of the substrate W. Accordingly, the chemical step by the chemical puddle treatment is performed.

After the chemical puddle treatment is performed over a predetermined time, the controller 20 rotates the spin chuck 2 by controlling the rotation drive mechanism 3 while the chemical valve 9 is in a closed state to stop the discharge of the chemical from the chemical nozzle 5. Thus, the substrate W rotates and the chemical on the substrate W is removed outward under a centrifugal force (Step S3). The controller 20 rotates the spin chuck 2 over a predetermined time, and then controls the rotation drive mechanism 3 to stop the rotation of the spin chuck 2.

Next, the controller 20 opens the deionized water valve 12 to supply deionized water from the deionized water nozzle 6 onto the upper surface of the stationary substrate W. Thus, the deionized water is puddled on the upper surface of the substrate W to form a liquid film of the deionized water (Step S4). The deionized water is substituted for a residual chemical present on the substrate W. The controller 20 closes the deionized water valve 12 after the lapse of a predetermined time in which the deionized water spreads all over the upper surface of the substrate W. However, in order to reliably maintain the state in which the entire upper surface of the substrate W is covered with the deionized water film, the supply of the deionized water from the deionized water nozzle 6 (preferably supply at a smaller flow rate than the initial supply flow for liquid film formation) may be continued.

The controller 20 maintains the state where the deionized water is puddled on the upper surface of the substrate W over a certain time to perform a first rinsing step, and thereafter, rotates the spin chuck 2 by controlling the rotation drive mechanism 3 while the deionized water valve 12 is in a closed state to stop the discharge of the deionized water from the deionized water nozzle 6. Thus, the deionized water (containing a chemical dissolved therein) on the upper surface of the substrate W is drained by a centrifugal force (Step S5). The controller 20 rotates the spin chuck 2 over a predetermined time, and then controls the rotation drive mechanism 3 to stop the rotation of the spin chuck 2.

The controller 20 subsequently opens the deionized water valve 12 to supply deionized water from the deionized water nozzle 6 toward the stationary substrate W. Thus, the deionized water is puddled on the upper surface of the substrate W to form a liquid film of the deionized water (Step S6: Second rinsing step). Accordingly, the surface of the substrate W after the chemical treatment is subjected to the deionized water rinsing treatment twice.

The controller 20 closes the deionized water valve 12 after waiting for a time required for supply of the deionized water necessary to cover the entire upper surface of the substrate W. However, in order to reliably maintain the state in which the entire upper surface of the substrate W is covered with the deionized water film, the supply of the deionized water from the deionized water nozzle 6 (preferably supply at a smaller flow rate than the initial supply flow for liquid film formation) may be continued.

Thereafter, the controller 20 changes the ambient air in the treatment chamber 1, particularly ambient air near the upper surface of the substrate W, into an ambient of carbon dioxide by opening the carbon dioxide valve 15 over a predetermined time while the deionized water valve 12 is closed (Step S7). Thus, the deionized water puddled on the upper surface of the substrate W incorporates carbon dioxide therein to produce a dilute CO₂-dissolved water, and the resistivity thereof falls down to the order of ten megohms immediately (e.g., in 2 to 3 seconds). As a result, an electric removing path connected to the holding pins 2a from the liquid film of the diluted CO₂-dissolved water thus obtained is formed. As described above, the holding pins 2a are of a conductive member, and electrically connected to the rotation shaft 4 through the electric discharge path 21. Therefore, static electricity produced on the substrate W is removed from the liquid film of the diluted CO₂-dissolved water, which becomes conductive, via a ground path passing through the holding pins 2a, the electric removing path 21 in the spin base 2b, and the rotation shaft 4 to the ground.

The controller 20 waits for the lapse of a predetermined time (e.g., for 2 to 3 seconds) from the supply of carbon dioxide, and thereafter controls the rotation drive mechanism 3 to rotate the spin chuck 2 (Step S8). Thus, the liquid component on the substrate W surface thus rotated together with the spin chuck 2 is spun off by a centrifugal force and discharged. Thereafter, the controller 20 accelerates the rotation speed of the spin chuck 2 up to a predetermined dry rotation speed (e.g., 300 rpm) to dry the substrate (Step S9). After rotating the spin chuck 2 at the dry rotation speed over a predetermined time, the controller 20 controls the rotation drive mechanism 3 to stop the rotation of the spin chuck 2 stops.

Thereafter, the substrate W thus treated is carried out of the treatment chamber 1 by the substrate transfer robot (Step S10).

Accordingly, the treatment of one substrate W is completed. If there is another substrate W to be treated, the same treatment is repeated.

As described above, according to this embodiment, the static electricity caused by the triboelectric charge and stripping charge produced when deionized water is supplied to a substrate W from the deionized water nozzle 6 or when the deionized water thus supplied is drained by rotating the substrate W, is removed by supplying carbon dioxide to the deionized water puddled on the upper surface of the substrate W afterwards. That is, a small amount of carbon dioxide is supplied toward near the upper surface of the substrate W from the gas nozzle 7 while deionized water is puddled, whereby the carbon dioxide is incorporated into the deionized water film on the substrate W. In this way, the deionized water film where the resistance is reduced due to the dissolution of the carbon dioxide forms an electric removing path to the holding pins 2a made of a conductive member. Therefore, the static electricity accumulated on the substrate W in the previous treatment can be dissipated to the electric removing path 21 through the deionized water film having carbon dioxide dissolved therein and the holding pins 2a. This allows completion of the treatment to the substrate W while static electricity is removed therefrom.

In addition, as compared with the conventional techniques of supplying to a substrate a CO₂-dissolved water prepared by dissolving carbon dioxide in deionized water in piping, or by bubbling carbon dioxide in deionized water, this embodiment has an effect that the impurities in carbon dioxide are less prone to adhere to the substrate W. That is, even if impurities are contained in the carbon dioxide supplied from the gas nozzle 7, not all the impurities are adhered to the substrate W, and smaller amount of carbon dioxide is used as compared with the case where CO₂-dissolved water is prepared by blending in piping, or other process. As a result, contamination of the substrate W by the impurities in the carbon dioxide can be reduced.

Further, in the conventional technique of discharging a CO₂-dissolved water from a nozzle to perform the rinsing step for a substrate, the CO₂-dissolved water is in contact with the substrate for a long time. As a result, a problem may arise that the copper film and other metal films formed on the substrate surface are subjected to corrosion. In contrast, since the above embodiment is adapted to dissolve carbon dioxide in the liquid film of the deionized water puddled on the substrate W, the contact time of the CO₂-dissolved water with the upper surface of the substrate W is shortened. This allows minimization of the corrosion of the metal film formed on the surface of the substrate W.

As described above, the substrate W maybe a glass substrate for producing liquid crystal panels, or a semiconductor wafer for producing semiconductor devices. Not only when the substrate is formed of an insulator such as a glass substrate but also when the substrate is a semiconductor substrate having an insulating layer, such as an oxide film and a nitride film, formed on a surface thereof, the substrate W is disadvantageously charged. However, according to this embodiment, the treatment of the substrate W can be completed with static electricity being removed from the substrate W, so that the pattern defects on the substrate W or breakdown of the devices can be suppressed effectively.

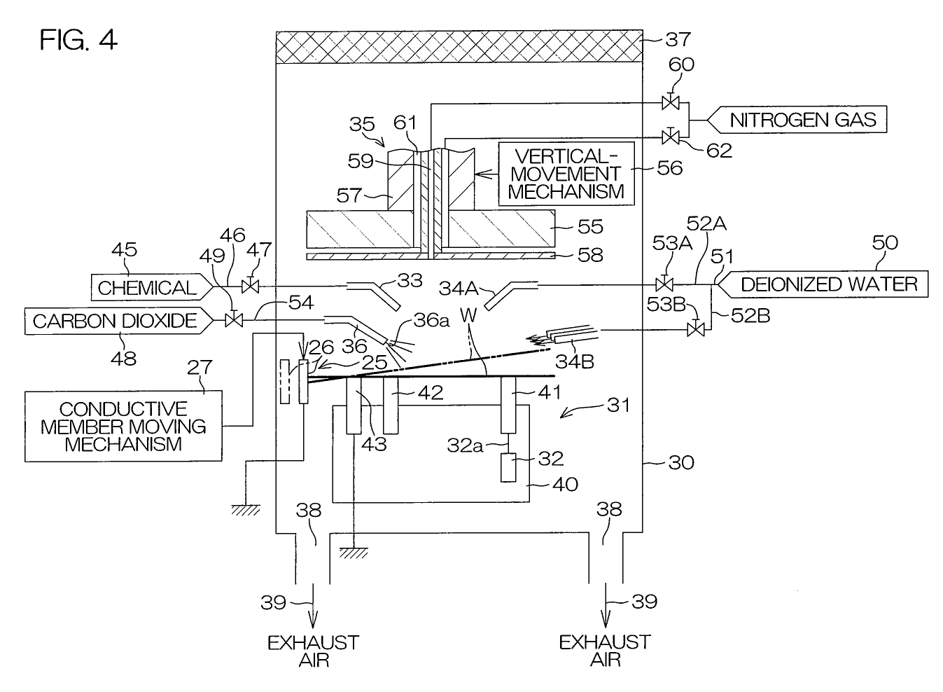

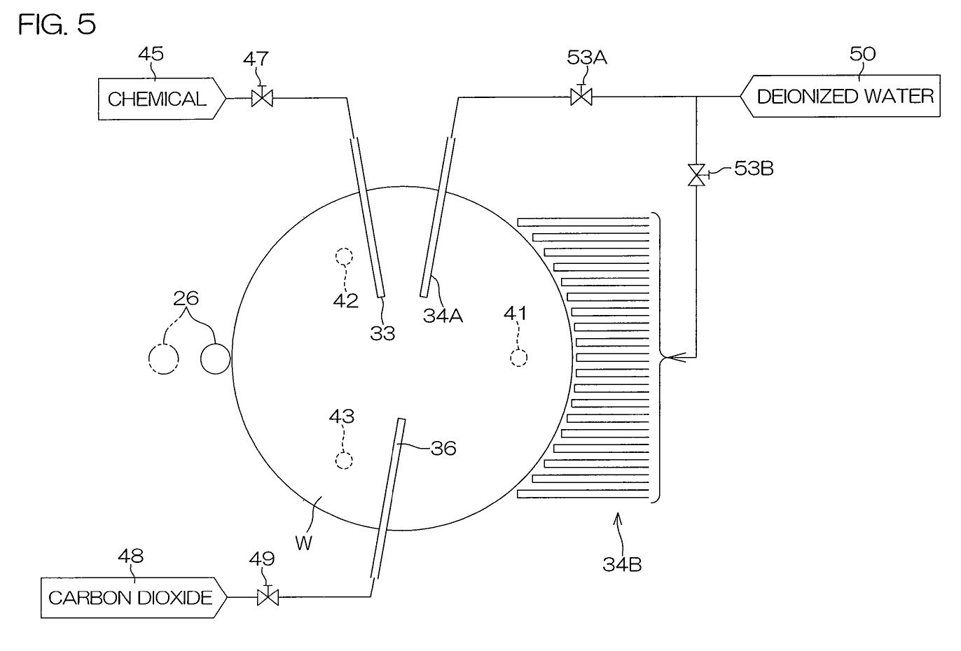

FIG. 4 is a schematic sectional view for explaining the arrangement of a substrate treatment apparatus according to a second embodiment of the present invention, and FIG. 5 is a schematic plan view thereof. The substrate treatment apparatus is adapted to, for example, treat a substrate W such as a semiconductor wafer or a glass substrate for producing liquid crystal panels for liquid crystal projectors using a chemical and deionized water.

This substrate treatment apparatus is of a single substrate processing type to treat a substrate W one-by-one in a treatment chamber 30. The treatment chamber 30 comprises a substrate holding mechanism 31, a cylinder 32 (substrate inclining mechanism, deionized water removal unit) as a substrate posture changing mechanism, a chemical nozzle 33, a first deionized water nozzle 34A (deionized water supply unit) and a second deionized water nozzle 34B, a substrate drying unit 35, a carbon dioxide nozzle 36 (resistivity reducing gas supply unit), and an electric removing mechanism 25.

The substrate holding mechanism 31 is adapted to hold one substrate W so that the substrate W is held in a non-rotating state with its device forming surface facing upward. The substrate holding mechanism 31 comprises a base 40 and three support pins 41, 42, 43 projected from the upper surface of the base 40. The support pins 41, 42, 43 are each arranged at locations corresponding to the apexes of an equilateral triangle of which the center of the substrate W is a median point (however, for convenience, the support pins 41, 42, 43 are shown in different arrangement in FIG. 4 from their actual arrangements). These support pins 41, 42, 43 are arranged along the vertical direction. Among them, the support pin 41 is vertically movably attached to the base 40. The support pins 41, 42, 43 are adapted to support the substrate W by bringing their head portions abutment against the lower surface of the substrate W.

The cylinder 32 is adapted to change the posture of the substrate W held by the substrate holding mechanism 31 into a horizontal posture and an inclined posture. A drive shaft 32a of the cylinder 32 is coupled to the support pin 41. Therefore, the cylinder 32 is driven, so that the support pin 41 changes the substrate support height, thus enabling the posture of the substrate W to be changed between the horizontal posture and the inclined posture. More specifically, when the cylinder 32 is driven to elevate the substrate support height of the support pin 41 higher than that of the other two support pins 42, 43, the posture of the substrate W becomes the inclined posture (e.g., posture at an angle of 3 degrees to a horizontal plane) orienting downward to the center of the substrate W from the support pin 41.

In this embodiment, the chemical nozzle 33 is a straight nozzle which discharges a chemical toward a generally center of the substrate W. A chemical from a chemical supply source 45 is supplied to the chemical nozzle 33 through a chemical supply pipe 46. A chemical valve 47 is provided in the chemical supply pipe 46, and opening and closing of the chemical valve 47 enable turning on and off of the discharge of the chemical from the chemical nozzle 33.

Deionized water passes through a deionized water supply pipe 51 from a deionized water supply source 50, and further flows while branching to a first branch pipe 52A and a second branch pipe 52B for the first and second deionized water nozzles 34A and 34B, respectively. A first and a second deionized water valves 53A, 53B are provided in the first and the second branch pipes 52A, 52B, respectively. Therefore, opening and closing of the first deionized water valve 53A and the second deionized water valve 53B, enable turning on and off of the discharge of the deionized water from the first deionized water nozzle 34A and the second deionized water nozzle 34B, respectively.

In this embodiment, the first deionized water nozzle 34A has a shape of a straight nozzle which supplies deionized water toward a generally center of the substrate W. On the other hand, in this embodiment, the second deionized water nozzle 34B is formed of a plurality of side nozzle groups which supply deionized water from the side to the upper surface of the substrate W held by the substrate holding mechanism 31. The plurality of side nozzle groups have outlet ports arranged in an arc along the outer circumference of the substrate W and discharge deionized water in a generally parallel direction to the upper surface of the substrate W. Thus, the second deionized water nozzle 34B functions as a water flow forming unit which forms a flow of deionized water on the upper surface of the substrate W.

The carbon dioxide nozzle 36 has an outlet port 36a (gas outlet port) in the treatment chamber 30, and supplies carbon dioxide which serves as a resistivity reducing gas supplied through a carbon dioxide supply pipe 54 from a carbon dioxide supply source 48, from the outlet port 36a toward the upper surface of the substrate W. A carbon dioxide valve 49 is provided in the carbon dioxide supply pipe 54, and opening and closing of the carbon dioxide valve 49 enables turning on and off of the discharge of the carbon dioxide from the carbon dioxide nozzle 36.

The electric removing mechanism 25 comprises a conductive member 26 grounded electrically and a conductive member moving mechanism 27 for moving the conductive member 26 toward and away from the substrate W. The conductive member moving mechanism 27 moves the conductive member 26 between an electric removing position (position shown in solid line) where the conductive member 26 is in contact with the liquid film present on the substrate W held by the substrate holding mechanism 31 near the peripheral surface of the substrate W, and a retreated position (position shown in double-dashed-chain line) where the conductive member 26 is retreated from the substrate holding mechanism 31. Therefore, while a liquid film having a low resistivity (specifically, deionized water having dissolved carbon dioxide therein) is puddled on the substrate W, the conductive member 26 is guided to the electric removing position, and then comes into contact with the liquid film, so that the static electricity accumulated on the substrate W can be removed.

The conductive member 26 is formed of PEEK or other conductive materials. The electric removing position of the conductive member 26 is close to the substrate edge opposed to the support pin 41 across the center of the substrate W. Therefore, when the support pin 41 is raised to set the substrate W in the inclined posture, the conductive member 26 at the electric removing position contacts the liquid film on the substrate W in the lower-most portion of the substrate W. That is, the electric removing position of the conductive member 26 is determined such that even if the conductive member 26 cannot contact the liquid film on the upper surface of the substrate W in the horizontal posture, when the substrate W is inclined, the conductive member 26 reliably contacts the liquid film.

The substrate drying unit 35 is arranged above the substrate holding mechanism 31. The substrate drying unit 35 has a disc-shaped plate heater (e.g., heater made of ceramics) 55 having substantially the same diameter as the substrate W. The plate heater 55 is generally horizontally supported by a support cylinder 57 which is raised and lowered by a vertical-movement mechanism 56. Further, a thin, disc-shaped filter plate 58 having substantially the same diameter as the plate heater 55 is provided below the plate heater 55 generally horizontally (that is, generally parallel to the plate heater 55). The filter plate 58 is made of quartz glass, and the disc-shaped plate heater 55 can irradiate the upper surface of the substrate W with infrared rays through the filter plate 58 of quartz glass.

A first nitrogen gas supply passage 59 for supplying a nitrogen gas, of which the temperature is controlled to substantially room temperature (about 21 to 23° C.) as cooling gas, toward a center portion of the upper surface of the substrate W is formed in the support cylinder 57. The nitrogen gas supplied from the first nitrogen gas supply passage 59 is supplied to a space between the upper surface of the substrate W and the lower surface (substrate opposing surface) of the filter plate 58. Nitrogen gas is supplied to the first nitrogen gas supply passage 59 through a nitrogen gas valve 60.

Further, a second nitrogen gas supply passage 61 for supplying a nitrogen gas, of which the temperature is controlled to substantially room temperature (about 21 to 23° C.) as cooling gas, into a space between the upper surface of the filter plate 58 and the lower surface of the plate heater 55 is formed around the first nitrogen gas supply passage 59. The nitrogen gas supplied from the second nitrogen gas supply passage 61 is supplied to the space between the upper surface of the filter plate 58 and the lower surface of the plate heater 55. Nitrogen gas is supplied to the second nitrogen gas supply passage 61 through a nitrogen gas valve 62.

When the substrate W on the substrate holding mechanism 31 is dried, the plate heater 55 is energized, and the nitrogen gas valves 60, 62 are opened. At the same time, the substrate opposing surface (lower surface) of the filter plate 58 is brought close to the surface of the substrate W (e.g., close to a distance of about 1 mm). Thus, the moisture on the substrate W surface is evaporated with infrared rays passed through the filter plate 58.

The filter plate 58 made of quartz glass absorbs the infrared rays in some wavelength regions among infrared rays. That is, of the infrared rays irradiated from the plate heater 55, the infrared rays of a wavelength which quartz glass absorbs are blocked by the filter plate 58, so that the substrate W is hardly irradiated therewith. Therefore, the substrate W is selectively irradiated with the infrared rays in a wavelength region which the filter plate 58, i.e., quartz glass, allows to transmit. Specifically, the plate heater 55 made of an infrared ceramic heater irradiates infrared rays having a wavelength region of about 3 to 20 μm. For example, a 5 mm-thick quartz glass absorbs infrared rays having a wavelength of 4 μm or more. Therefore, when such infrared ceramic heater and quartz glass are used, the substrate W is selectively irradiated with infrared rays having a wavelength of from about 3 μm to less than 4 μm.

On the other hand, water has the property of absorbing particularly infrared rays having wavelengths of 3 μm and 6 μm. The energy of the infrared rays absorbed by water vibrates water molecules, thereby producing frictional heat among the vibrated water molecules. That is, water can be efficiently heated to dry by irradiating water with the infrared rays of a wavelength which water particularly absorbs. Therefore, when infrared rays having a wavelength of about 3 μm are irradiated onto the substrate W, fine liquid droplets of deionized water adhering thereon absorb the infrared rays, and are dried with heat.

In the case of a silicon substrate, the substrate W itself has the property of absorbing infrared rays having a longer wavelength than 7 μm, and of transmitting those having a shorter wavelength than 7 μm. For this reason, when the infrared rays having a wavelength of 3 μm is irradiated, the substrate is hardly heated. That is, of those irradiated from the infrared ceramic heater, the infrared rays of a wavelength region, which are efficiently absorbed by water and transmit the substrate W itself, are selectively irradiated onto the substrate W, thereby enabling the fine liquid droplets adhering to the substrate W to be efficiently dried with heat, while the substrate W itself is hardly heated. As the filter plate 58, materials may be used such that the infrared rays having a wavelength efficiently absorbed by water are allowed to transmit and such that the infrared rays having a wavelength absorbed by the substrate W are absorbed.

When the plate heater (ceramic heater) 55 is energized, transfer of convective heat may be conceivable from the plate heater 55 to the substrate W, but such heat transfer is blocked by the filter plate 58. However, temperature in the space between the lower surface of the plate heater 55 and the upper surface of the filter plate 58 increases due to the convective heat, thereby gradually heating the filter plate 58. This convective heat from the filter plate 58 is then transferred to the substrate W, which in turn is liable to heat the substrate W. Therefore, nitrogen gas is supplied as cooling gas to the space between the lower surface of the plate heater 55 and the upper surface of the filter plate 58, thereby suppressing elevation of temperature in the space. Although the filter plate 58 absorbs the infrared rays from the plate heater 55, the supply of the nitrogen gas to between the plate heater 55 and the filter plates 58 can also suppress elevation of temperature of the filter plate 58 and can further prevent the substrate W from being heated due to the convective heat from the filter plate 58.

A filter unit 37 for further filtering clean air in the clean room where the substrate treatment apparatus is installed, thereby introducing the filtered air into the treatment chamber 30 is provided in the upper portion of the treatment chamber 30. An exhaust port 38 is formed in the lower potion of the treatment chamber 30. The exhaust port 38 is connected, to an exhaust utility in the plant through an exhaust pipe 39.

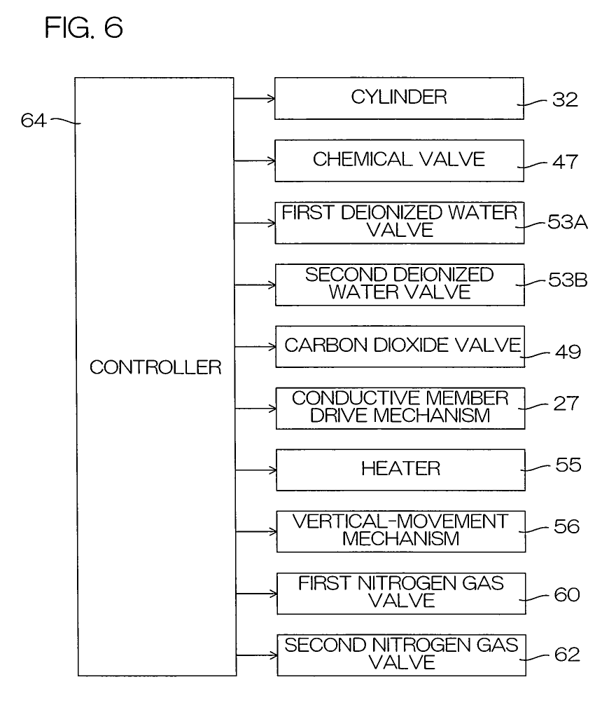

As shown in FIG. 6, a controller 64 including a microcomputer controls operations of the cylinder 32, the chemical supply valve 47, the first and second deionized water valves 53A, 53B, the carbon dioxide valve 49, the conductive member moving mechanism 27, the heater 55, the vertical-movement mechanism 56, and the nitrogen gas valves 60, 62 as described above.

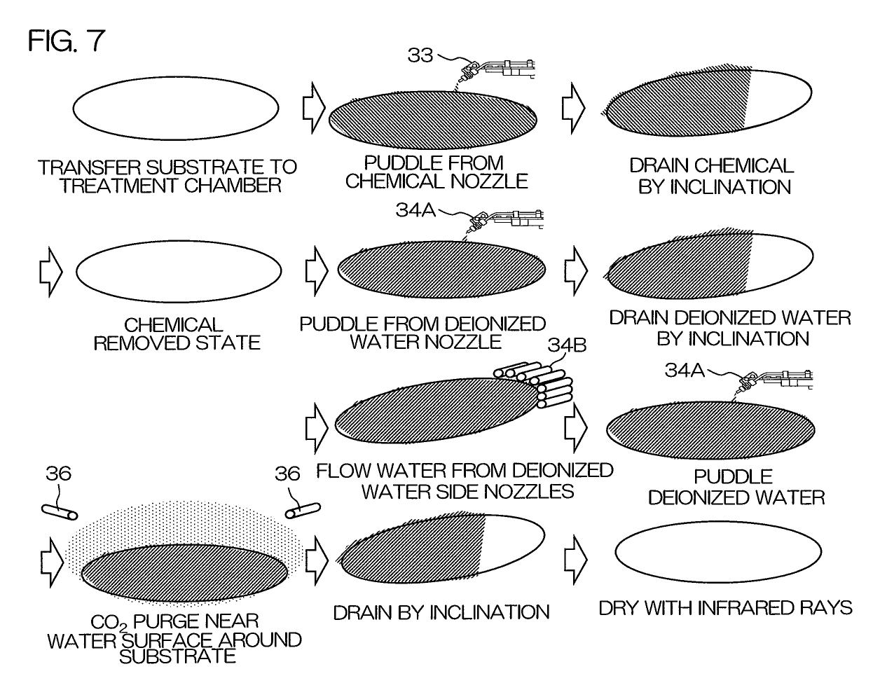

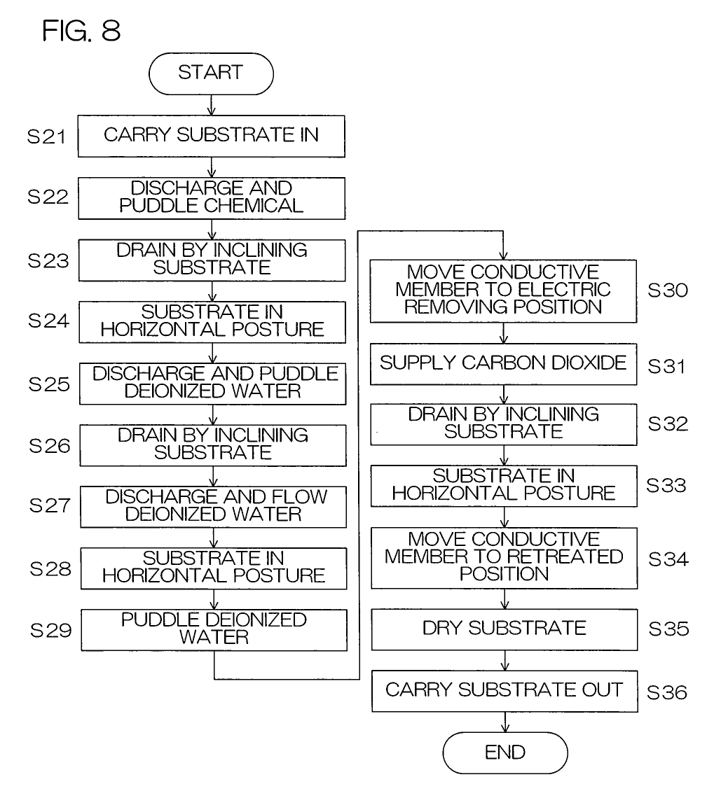

FIG. 7 is a schematic diagram illustrating an example of a treatment flow of a substrate W in sequence of steps, and FIG. 8 is a flowchart for explaining the operation of a substrate treatment apparatus corresponding to the treatment flow.

The unprocessed substrate W is carried into the substrate treatment apparatus by the substrate transfer robot, which is not shown, and is transferred to the support pins 41, 42, 43 of the substrate holding mechanism 31 (Step S21). At this time, the cylinder 32 is contracting its drive shaft 32a, so that the support pin 41 is in a lowered position, and the support pins 41, 42, 43 have equal substrate support height. Therefore, the substrate W is horizontally supported. Further, the controller 64 controls the conductive member moving mechanism 27 to retreat the conductive member 26 to the retreated position.

From such state, the controller 64 opens the chemical valve 47 to discharge the chemical from the chemical nozzle 33 toward the upper surface of the substrate W. Thus, the chemical is puddled on the upper surface of the substrate W (Step S22, Chemical Step). When the chemical spreads all over the upper surface of the substrate W, the controller 64 closes the chemical valve 47 to stop the supply of the chemical. However, in order to reliably maintain the state in which the entire upper surface of the substrate W is covered with the chemical, the chemical supply from the chemical nozzle 33 (preferably supply at a smaller flow rate than the initial supply flow for liquid film formation) may be continued.

After the chemical puddle state is maintained for a certain time, the controller 64 drives the cylinder 32 to raise the substrate support height of the support pin 41 while the chemical valve 47 is kept in its closed state. Thus, the substrate W inclines toward the support pins 42, 43 from the support pin 41 to have an inclined posture. Accordingly, the chemical on the upper surface of the substrate W flows downward to be drained from the upper surface thereof (Step S23).

Next, the controller 64 drives the cylinder 32 to return the substrate support height of the support pin 41 to its original height. Thus, the substrate W is again placed in the horizontal posture (Step S24).

In this state, the controller 64 opens the first deionized water valve 53A only for a certain time. Thus, deionized water is discharged toward the upper surface of the substrate W from the first deionized water nozzle 34A having a shape of a straight nozzle. By discharging the deionized water over a predetermined time, the deionized water is puddled on the upper surface of the substrate W (Step S25, Puddle Rinsing Step). However, in order to reliably maintain the state in which the entire upper surface of the substrate W is covered with the deionized water film, the deionized water supply from the first deionized water nozzle 34A (preferably supply at a smaller flow rate than the initial supply flow for liquid film formation) may be continued.

Subsequently, while the first deionized water valve 53A is kept in its closed state, the controller 64 drives the cylinder 32 to raise the support pin 41, so that the substrate W is placed in an inclined posture (Step S26). Thus, the deionized water (containing some chemical remaining on the substrate W after the chemical treatment process in diluted state) on the substrate W is flown down from the upper surface thereof to be removed.

Next, the controller 64 opens the second deionized water valve 53B to have the second deionized water nozzle 34B supply deionized water from the side toward the upper surface of the substrate W, while the substrate W is kept in an inclined posture. Thus, a water flow from the second deionized water nozzle 34B toward the support pins 42, 43 is formed on the substrate W (Step S27, Water Flow Rinsing Step). The deionized water flows down from the substrate W, whereby the water flow washes away the residual chemical and other contaminants on the substrate W.

In this way, after the water flow is formed on the upper surface of the substrate W only for a certain time for water flow washing, the controller 64 closes the second deionized water valve 53B to stop the discharge of deionized water. Thereafter, the controller 64 drives the cylinder 32 to return the substrate support height of the support pin 41 to its original height. Thus, the substrate W is placed in the horizontal posture (Step S28).

Subsequently, the controller 64 opens the first deionized water valve 53A to discharge deionized water toward the upper surface of the substrate W from the first deionized water nozzle 34A. Thus, the deionized water is puddled on the upper surface of the substrate W (Step S29, Second Puddle Rinsing Step). When the deionized water spreads all over the upper surface of the substrate W to form a deionized water film which covers the entire upper surface thereof, the controller 64 closes the first deionized water valve 53A to stop the discharge of the deionized water from the first deionized water nozzle 34A.

During or after the puddling of the deionized water onto the substrate W, the controller 64 controls the conductive member moving mechanism 27 to guide the conductive member 26 to an electric removing position (Step S30). Thus, the conductive member 26 contacts the deionized water film on the substrate W.

On the other hand, the controller 64 opens the carbon dioxide valve 49 after a puddle of deionized water is formed on the substrate W (Step S31). Thus, carbon dioxide from the carbon dioxide supply source 48 is supplied to the carbon dioxide nozzle 36 through the carbon dioxide supply pipe 54, and the carbon dioxide thus supplied is discharged from the outlet port 36a of the carbon dioxide nozzle 36 toward the upper surface of the substrate W. This changes the ambient air to which the deionized water film covering the upper surface of the substrate W is exposed into an ambient of the carbon dioxide. The deionized water film on the upper surface of the substrate W immediately incorporates carbon dioxide existing in the ambient air to become a CO₂-dissolved water having the carbon dioxide dissolved therein. As a result, a liquid film of the CO₂-dissolved water on the substrate W has a low resistivity as compared with that of deionized water. Therefore, the static electricity accumulated on the substrate W during the puddling of deionized water and during the water flow formation is dissipated to the ground path which passes through the liquid film to the conductive member 26.

After the carbon dioxide is supplied near the upper surface of the substrate W, the controller 64 waits for the lapse of a certain time, and thereafter operates the cylinder 32. That is, the cylinder 32 extends its drive shaft 32a. Thus, the support pin 41 is raised, so that the substrate W is placed in an inclined posture. Accordingly, the deionized water liquid film (having trace carbon dioxide dissolved therein) on the upper surface of the substrate W is flown down from the upper surface thereof to be drained (Step S32).

When the liquid film on the upper surface of the substrate W is removed, the controller 64 controls the cylinder 32 to lower the support pin 41. This returns the substrate W to the horizontal posture (Step S33).

Further, the controller 64 controls the conductive member moving mechanism 27 to guide the conductive member 26 to the retreated position (Step S34). The conductive member 26 is in its electric removing position even when deionized water is removed by inclining the substrate W. Therefore, even if the substrate W having the horizontal posture cannot contact the liquid film, when the substrate W is inclined, the conductive member 26 reliably contacts the deionized water liquid film during drainage. This ensures electric removing of the substrate W.

Subsequently, the controller 64 controls the vertical-movement mechanism 56 to lower the plate heater 55 to a predetermined treatment position where the substrate opposing surface (lower surface) of the filter plate 58 is as close as a predetermined distance (e.g., 1 mm) to the upper surface of the substrate W. Of course, prior to this operation, the chemical nozzle 33 and the deionized water nozzles 34A, 34B are retreated to the outside of the substrate W. In this state, the controller 64 energizes the plate heater 55. Thus, water droplets remaining on the substrate W after the inclined drainage are evaporated by the infrared rays which pass through the filter plate 58 to reach the substrate W surface. Further, the controller 64 opens the nitrogen gas valves 60, 62 to supply nitrogen gas into the first and second nitrogen gas supply passages 59, 61, respectively. Thus, the nitrogen gas (cooling gas) which is temperature-controlled to room temperature is supplied to the space between the substrate W and the filter plate 58, and the space between the filter plate 58 and the plate heater 55. This allows suppression of the heat transfer to the substrate W from the plate heater 55 and the filter plate 58, and at the same time, the upper surface of the substrate W is maintained in an ambient of nitrogen gas, and the infrared rays are absorbed by the water droplets remaining on the upper surface of the substrate W, so that the substrate drying process can be performed (Step S35).

After this drying process, the processed substrate W is carried out of the apparatus by the substrate transfer robot (Step S36).

Accordingly, the treatment of one substrate W is completed. If there is another unprocessed substrate W to be treated, the same treatment is repeated.

Thus, even with this embodiment, after deionized water is puddled on the upper surface of the substrate W, the ambient air on the upper surface of the substrate W is turned into the ambient of carbon dioxide, so that the resistivity of the deionized water film on the substrate W is lowered, thereby removing static electricity accumulated on the substrate W. Therefore, the treatment with respect to the substrate W can be completed with almost no charge on the substrate W. Further, in this embodiment, since the chemicals and deionized water are removed from the upper surface of the substrate W by inclining the substrate W, the amount of the chemical or deionized water scattered in the treatment chamber 30 is small, so that the space in the treatment chamber 30 can be kept clean.

In the foregoing description, the conductive member 26 is brought into contact with the deionized water (deionized water having carbon dioxide dissolved therein) on the substrate W to form an electric removing path. However, for example, at least any one of the support pins 41 to 43 is formed of a conductive member and connected to ground potential (see FIG. 4). At the same time, the support pin may be brought into contact with the liquid film on the substrate W at least when the substrate W is inclined. If such arrangement is made, the conductive member 26 and the conductive member moving mechanism 27 are no longer required.

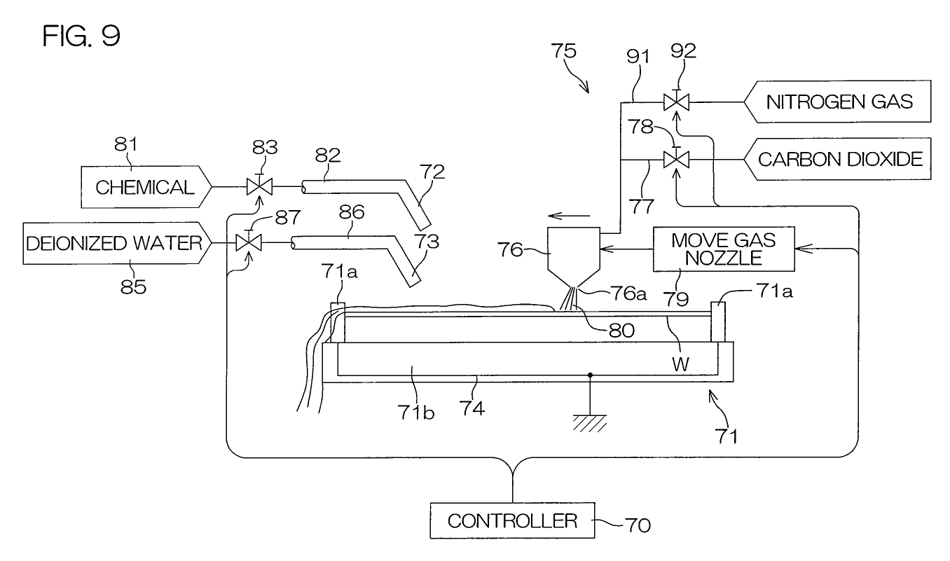

FIG. 9 is a schematic diagram for explaining the arrangement of a substrate treatment apparatus according to a third embodiment of the present invention. The substrate treatment apparatus comprises a substrate holding mechanism 71 which horizontally holds a substrate W, a chemical nozzle 72 which discharges a chemical toward the upper surface of the substrate W held by the substrate holding mechanism 71, a deionized water nozzle 73 (deionized water supply unit) which discharges deionized water toward the upper surface of the substrate W held by the substrate holding mechanism 71, and a gas knife mechanism 75 (gas nozzle unit, resistivity reducing gas supply unit, and deionized water removal unit) which can horizontally move above the substrate W held by the substrate holding mechanism 71 in the treatment chamber (not shown).

The substrate holding mechanism 71 comprises a plurality of holding pins 71a which holds a substrate W, and a base portion 71b having the holding pins 71a installed upright on its upper surface. The holding pins 71a are a conductive member made of conductive PEEK or other conductive materials. The holding pins 71a are electrically connected to an electric discharge path 74 provided in the base portion 71b. The electric discharge path 74 is connected to ground potential.

A chemical from a chemical supply source 81 is supplied to the chemical nozzle 72 through a chemical supply pipe 82, and a chemical valve 83 is provided in the chemical supply pipe 82. Deionized water from a deionized water supply source 85 is supplied to the deionized water nozzle 73 through a deionized water supply pipe 86, and a deionized water valve 87 is provided in the deionized water supply pipe 86.

The gas knife mechanism 75 comprises a gas nozzle 76 having a straight slot-shaped gas outlet port 76a extending in the direction vertical to the plane of FIG. 9, a carbon dioxide supply pipe 77 which supplies carbon dioxide as a resistivity reducing gas to the gas nozzle 76, a carbon dioxide valve 78 provided in the carbon dioxide supply pipe 77, a nitrogen gas supply pipe 91 which supplies nitrogen gas as inert gas to the gas nozzle 76, a nitrogen gas valve 92 provided in the nitrogen gas supply pipe 91, and a gas nozzle moving mechanism 79 which horizontally moves the gas nozzle 76 above the substrate holding mechanism 71. The gas nozzle 76 forms a gas knife 80 with the carbon dioxide or the nitrogen gas discharged from the gas outlet port 76a. The gas knife 80 forms a linear gas blowing area on a surface of the substrate W. The gas blowing area extends over a longer range than the diameter of the substrate W.

The controller 70 controls operations of the carbon dioxide valve 78, the nitrogen gas valve 92, the gas nozzle moving mechanism 79, the chemical valve 83, and the deionized water valve 87.

The controller 70 opens the chemical valve 83 over a certain time while an unprocessed substrate W is horizontally held by the substrate holding mechanism 71, thereby forming a chemical liquid film which covers the entire upper surface of the substrate W on the upper surface of the substrate W. In this way, the chemical is puddled on the substrate W, enabling substrate treatment with the chemical. After such chemical puddle treatment is performed over a predetermined time, the controller 70 operates the gas knife mechanism 75 in order to remove the chemical present on the substrate W. Specifically, the controller 70 opens the nitrogen gas valve 92 to supply nitrogen gas to the gas nozzle 76 and also operates the gas nozzle moving mechanism 79. Thus, the gas nozzle 76 scans the upper surface of the substrate W in one direction from one peripheral edge to the other peripheral edge opposed thereto. As a result, the gas knife 80 which is formed with the nitrogen gas discharged from the gas nozzle 76 sweeps the chemical on the substrate W away therefrom.

Thereafter, the controller 70 closes the nitrogen gas valve 92 and moves the gas nozzle 76 to its initial position. Subsequently, it opens the deionized water valve 87 over a certain time. As a result, deionized water is puddled on the substrate W so as to form a deionized water film which covers the entire upper surface of the substrate W. In this way, a chemical component remaining on the substrate W is diluted in the deionized water film.

Next, the controller 70 operates the gas knife mechanism 75 to perform the treatment for removing the deionized water on the substrate W. Specifically, the controller 70 opens the nitrogen gas valve 92 and also operates the gas nozzle moving mechanism 79, so that the gas knife 80 scans the substrate W from one peripheral edge to the other opposed thereto. Thus, the deionized water on the substrate W is swept away from the upper surface thereof to be removed.

Next, the controller 70 opens the deionized water valve 87 over a certain time to discharge the deionized water from the deionized water nozzle 73 toward the upper surface of the substrate W. Thus, a deionized water film which covers the entire upper surface of the substrate W is again formed on the upper surface thereon.

Subsequently, the controller 70 operates to perform the treatment for removing the deionized water on the substrate W by the gas knife mechanism 75. However, at this time, the gas nozzle 76 discharges carbon dioxide. That is, the controller 70 opens the carbon dioxide valve 78, and at the same time, moves the gas nozzle 76 by the gas nozzle moving mechanism 79. Thus, the carbon dioxide discharged from the gas nozzle 76 forms a gas knife 80, and the gas knife 80 scans the upper surface of the substrate W in one direction from one peripheral edge to the other peripheral edge opposed thereto. As a result, the deionized water on the substrate W is swept away therefrom to be removed.

The carbon dioxide discharged from the gas nozzle 76 is immediately incorporated into the deionized water on the substrate W. As a result, in the process of removing the deionized water from the substrate W, the resistivity of the deionized water immediately lowers, and then turns into a low-concentration CO₂-dissolved water to flow down from the substrate W. At this time, the deionized water serving as the low-concentration CO₂-dissolved water is put in a state of being electrically connected to the holding pins 71a of the substrate holding mechanism 71. Therefore, when static electricity is accumulated on the substrate W, the static electricity is connected to the holding pins 71a through a liquid film of the deionized water serving as the low-concentration CO₂-dissolved water. The holding pins 71a are grounded through the electric discharge path 74 provided in the base portion 71b of the substrate holding mechanism 71, and therefore, the static electricity accumulated on the substrate W is removed in the process of removing the liquid film of the deionized water on the substrate W. Accordingly, the step of removing the deionized water on the substrate W, and the step of lowering the resistivity of the deionized water are performed simultaneously.

In the foregoing, three embodiments of the present invention have been discussed, but the present invention can also be embodied in a different manner. For example, in the first and second embodiments, the gas nozzle (7;36) is provided in order to introduce carbon dioxide into the treatment chamber (1;30). However, for example, carbon dioxide may be mixed with clean air introduced in the treatment chamber (1;30) through the filter unit (17;37), or the clean air introduced from the filter unit (17;37) may be changed to carbon dioxide, thereby producing an ambient of the carbon dioxide in the treatment chamber (1;30).

Further, in the first and second embodiments, the surroundings of the substrate W are turned into an ambient of carbon dioxide after the puddle treatment of deionized water. However, the ambient air in the treatment chamber (1;30) may be always maintained in the ambient of carbon dioxide.

In the first embodiment, the first deionized water rinsing treatment is performed by the puddle treatment of puddling deionized water on the substrate W. However, the first deionized water rinsing treatment may be performed by a continuous water injection process in which deionized water is continuously supplied from the deionized water nozzle 6 toward the rotation center of the substrate W in the upper surface thereof while the substrate W is rotated by the spin chuck 2.

Further, in the first embodiment, the rotation of the substrate W is stopped during the puddle treatment. However, during the time, the substrate W may be rotated at a low speed such that the liquid film can be maintained on the substrate W.

In the third embodiment, when deionized water is drained after the first deionized water puddle treatment, nitrogen gas is discharged from the gas nozzle 76, and then carbon dioxide is discharged from the gas nozzle 76 during the drainage of deionized water after the second deionized water puddle treatment. However, even when the deionized water is drained from the substrate W after the first puddle, carbon dioxide may be discharged from the gas nozzle 76. In addition, carbon dioxide may also be used as the gas discharged from the gas nozzle 76 after the chemical puddle treatment.

In the foregoing embodiments, carbon dioxide is used as the gas for reducing the resistivity of deionized water on the substrate W. However, like rare gases, such as xenon, krypton, and argon, or methane gas, as far as a gas can reduce the resistivity of deionized water by dissolving the gas in deionized water, the gas can be used for similar purpose.

As the carbon dioxide supply source, a carbon dioxide cylinder accommodating high purity carbon dioxide can be used, and dry ice may also be used as a carbon dioxide source.

Further, a carbon dioxide concentration measuring device which measures the concentration of carbon dioxide may be provided in the vicinity of the upper surface of the substrate W to control the supply of carbon dioxide depending on the measurement.

Embodiments of the present invention have been discussed in detail, but these embodiments are mere specific examples for clarifying the technical contents of the present invention. Therefore, the present invention should not be construed as limited to these specific examples. The spirit and scope of the present invention are limited only by the appended claims.

This Application corresponds to Japanese Patent Application Serial No. 2006-186758 filed on Jul. 6, 2006 with the Japan Patent Office, the disclosure of which is incorporated herein by reference.

What is claimed is:

1. A substrate treatment method, comprising:
a deionized water supply step of supplying deionized water on a surface of a substrate;
a resistivity reducing gas supply step of supplying a resistivity reducing gas so as to change ambient air to which the deionized water in contact with the surface of the substrate is exposed, into an ambient of the resistivity reducing gas capable of reducing the resistivity of deionized water; and
a deionized water removal step of removing the deionized water from the surface of the substrate after the resistivity reducing gas supply step.

2. A substrate treatment method according to claim 1, wherein the deionized water supply step, the resistivity reducing gas supply step, and the deionized water removal step are performed in a treatment chamber, and
the resistivity reducing gas supply step comprises a step of supplying a resistivity reducing gas in the treatment chamber.

3. A substrate treatment method according to claim 1, wherein the resistivity reducing gas supply step comprises a step of supplying a resistivity reducing gas toward the surface of the substrate.

4. A substrate treatment method according to claim 3, wherein the resistivity reducing gas supply step and the deionized water removal step are performed simultaneously.

5. A substrate treatment method according to claim 1, wherein the deionized water supply step comprises a deionized water puddle step of puddling deionized water on a surface of a substrate generally horizontally held by a substrate holding mechanism.

6. A substrate treatment method according to claim 1, wherein the deionized water removal step comprises a substrate inclining step of inclining a substrate having a horizontal posture, thereby flowing down the deionized water on the substrate.

7. A substrate treatment method according to claim 1, further comprising a grounding step of grounding the deionized water on the substrate through a conductive member.

8. A substrate treatment apparatus, comprising:
a treatment chamber;
a substrate holding mechanism which holds a substrate in the treatment chamber;
a deionized water supply unit which supplies deionized water to the substrate held by the substrate holding mechanism;
a resistivity reducing gas supply unit, having a gas outlet port in the treatment chamber, which discharges a resistivity reducing gas from the gas outlet port in order to change ambient air on a surface of the substrate held by the substrate holding mechanism into an ambient of the resistivity reducing gas capable of reducing the resistivity of deionized water; and
a deionized water removal unit which removes deionized water from the surface of the substrate held by the substrate holding mechanism.

9. A substrate treatment apparatus according to claim 8, wherein the resistivity reducing gas supply unit produces an ambient of resistivity reducing gas in the treatment chamber.

10. A substrate treatment apparatus according to claim 8, wherein the resistivity reducing gas supply unit supplies the resistivity reducing gas to a space in the vicinity of the surface of the substrate.

11. A substrate treatment apparatus according to claim 8, wherein the resistivity reducing gas supply unit comprises a gas nozzle unit which removes the deionized water on the substrate by blowing the resistivity reducing gas toward the surface of the substrate.

12. A substrate treatment apparatus according to claim 11, wherein the resistivity reducing gas supply unit also serves as the deionized water removal unit.

13. A substrate treatment apparatus according to claim 8, wherein the deionized water removal unit comprises a substrate inclining mechanism which inclines the substrate to flow down deionized water from the surface of the substrate.

14. A substrate treatment apparatus according to claim 8, further comprising a conductive member for grounding deionized water on the substrate.
